(19) United States
(12) Patent Application Publication
(10) Pub. No.: US 2026/0339716 A1
(43) Pub. Date: Oct. 29, 2026

(54) SECURE PLACEMENT OF WORKLOADS BASED ON TRUST SCORE CRITERIA

(71) Applicant: Dell Products L.P., Round Rock, TX (US)

(72) Inventors: Deepak Gaikwad, Natick, MA (US); Judith A. Furlong, Natick, MA (US)

(21) Appl. No.: 19/186,986

(22) Filed: Apr. 23, 2025

(51) Int. Cl. G06F 9/50; G06F 11/07; G06F 11/14; G06F 21/57

(52) U.S. Cl. CPC G06F 9/5027; G06F 11/0754; G06F 11/0766; G06F 11/0793; G06F 11/1438; G06F 21/577; G06F 2209/5011

(57) ABSTRACT

The embodiments disclosed herein relate to a method for executing workflows on computing systems selected from a resource pool. Each computing system comprises multiple computing resources and is assigned an overall trust score. The method involves accessing a workflow with a defined trust score threshold, which specifies the minimum trust score required for a computing system to execute the workflow. A first computing system is selected from the resource pool based on its overall trust score meeting or exceeding the trust score threshold. The workflow is then deployed for execution on the selected computing system. Additionally, the method includes generating an alert if the overall trust score of the first computing system falls below the trust score threshold during execution, ensuring that workflows are executed on systems that maintain the required level of trustworthiness.

### TECHNOLOGICAL FIELD OF THE DISCLOSURE

Embodiments disclosed herein generally relate to trust scoring. More particularly, at least some embodiments relate to systems, hardware, software, computer-readable media, and methods for securely placing workloads based on trust score criteria.

### BACKGROUND

Composed systems are an aggregation of distributed components from multiple geographic or manufacturer sources which need a reliable way to prove their security posture to the customers in a quantifiable way. To meet Zero Trust and other security objectives for their environment, customers may specify policies that require certain applications or workloads in their environment to only be run on secure and trustworthy systems, including composed systems. However, with the advent of large mix workloads including AI, compute storage, memory intensive, etc., that that require secure provisioning of resources from various systems, users have a need to assess the security and trustworthiness of the systems that will execute a user’s application or workload to ensure the system meets application or workload security policies.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1A and 1B disclose aspects of a secure resource management system according to the embodiments disclosed herein.

FIG. 2 discloses aspects of the operation of the secure resource management system according to the embodiments disclosed herein.

FIGS. 3A-3D disclose aspects of the operation of the secure resource management system according to the embodiments disclosed herein.

FIG. 4 discloses aspects of a method according to the embodiments disclosed herein.

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to trust scoring. More particularly, at least some embodiments relate to systems, hardware, software, computer-readable media, and methods for securely placing workloads based on trust score criteria.

The embodiments disclosed herein relate to a method for executing workflows on computing systems selected from a resource pool. Each computing system comprises multiple computing resources and is assigned an overall trust score. The method involves accessing a workflow with a defined trust score threshold, which specifies the minimum trust score required for a computing system to execute the workflow. A first computing system is selected from the resource pool based on its overall trust score meeting or exceeding the trust score threshold. The workflow is then deployed for execution on the selected computing system. Additionally, the method includes generating an alert if the overall trust score of the first computing system falls below the trust score threshold during execution, ensuring that workflows are executed on systems that maintain the required level of trustworthiness.

In some aspects, the embodiments disclosed herein relate to a method, including: accessing one or more computing systems from a resource pool, the one or more computing systems each including a plurality of computing resources, each of the one or more computing systems having an overall trust score; accessing a workflow that is to be executed by one of the one or more computing systems, the workflow having a trust score threshold that defines a minimum trust score that the one of the one or more computing systems is to have before being allowed to execute the workflow; selecting a first computing system of the one or more computing systems having an overall trust score that meets or exceeds the trust score threshold; deploying the workflow for execution on the first computing system; and generating an alert if the overall trust score of the first computing system falls below the trust score threshold.

In some aspects, the embodiments disclosed herein relate to a non-transitory storage medium having stored therein instructions that are executable by one or more hardware processors to perform operations including: accessing one or more computing systems from a resource pool, the one or more computing systems each including a plurality of computing resources, each of the one or more computing systems having an overall trust score; accessing a workflow that is to be executed by one of the one or more computing systems, the workflow having a trust score threshold that defines a minimum trust score that the one of the one or more computing systems is to have before being allowed to execute the workflow; selecting a first computing system of the one or more computing systems having an overall trust score that meets or exceeds the trust score threshold; deploying the workflow for execution on the first computing system; and generating an alert if the overall trust score of the first computing system falls below the trust score threshold.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

At least some of the embodiments disclosed herein may implement one or more machine learning models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

The embodiments disclosed herein provide for a novel framework that addresses the problems of ensuring that the security and trustworthiness of systems executing workloads meet a user’s expected security expectations. The embodiments disclosed herein enable late binding of sensitive applications or workloads to a secure composed system or static system by leveraging a real-time trust score of individual components of the composed system or static system based on customer specified policies. The embodiments disclosed herein allow secure placement of heterogenous workloads from a disaggregated pool of resource in the Zero Trust and other secure environments. The embodiments disclosed herein monitor changes in the trust score of the composed system or static system to allow for generating an alert and migrating the workload when a trust score threshold falls below the desired value specified in the customer’s remediation policy. Given that the trust score of the composed system or static system is calculated from the scores of the individual components of the composed system, the embodiments disclosed herein provide a way to identify which component(s) is(are) responsible for drifts in the trust score, thus allowing more specific remediation plans to be created

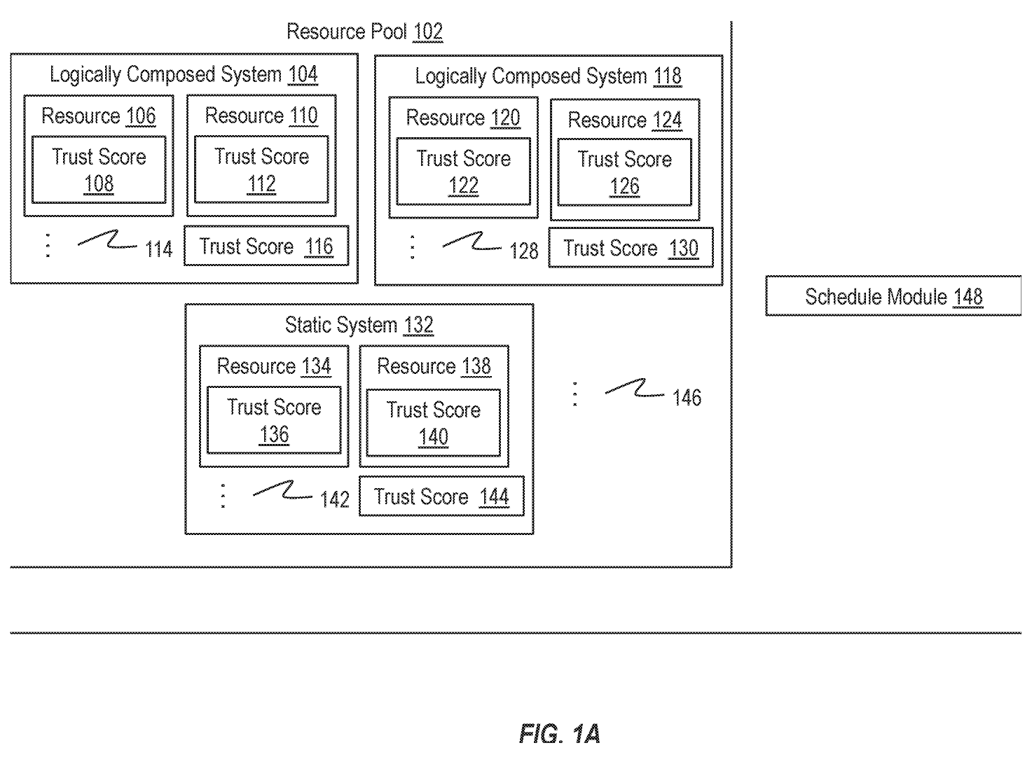

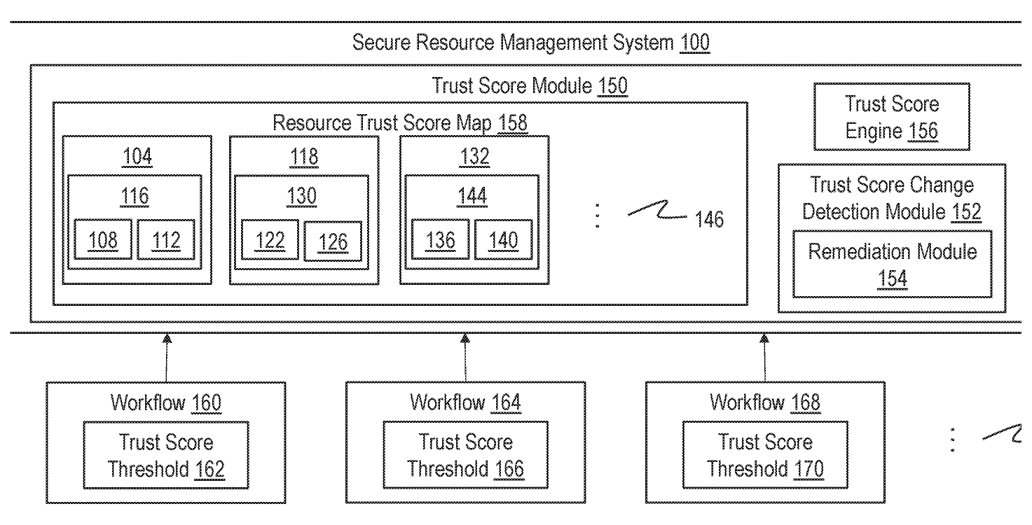

FIGS. 1A and 1B illustrate an embodiment of a secure resource management system 100. In some embodiments, secure resource management system 100 is a local system operating on a local device, such as an edge device. In some embodiments, secure resource management system 100 is a cloud system operating in a cloud or in another distributed computing environment. In some embodiments, secure resource management system 100 is a hybrid system that includes a cloud component operating in cloud or other distributed computing system and a local component operating on a local device. These two components can communicate with one another. As illustrated in FIGS. 1A and 1B, the secure resource management system 100 includes or is associated with a resource pool 102, a schedule module 148, and a trust score module 150, all of which will be described in more detail to follow.

The secure resource management system 100 is associated with the resource pool 102. In some embodiments, the resource pool 102 is part of the secure resource management system 100 and in other embodiments the resource pool 102 is accessible by the secure resource management system 100. As illustrated, the resource pool 102 includes a logically composed system 104, a logically composes system 118, a static system 132, and any number of additional systems 146, which can be logically composed systems and/or static system, as illustrated by the ellipses.

A logically composed system is a system made of various different computing resources that can be dynamically created as needed based on the workload the system will execute. For example, if a workload requires more processing resources than is typical for a workload, the composed system can dynamically be created to include more processing resources. Likewise, a workload that requires more compute memory resources than is typical for a workload, the composed system can dynamically be created to include more compute memory resources. A static system, on the other hand, is a system with set amounts and types of computing resources.

The resource pool 102 includes or otherwise has access to the logically composed system 104. The logically composed system 104 includes a computing resource 106, a computing resource 110, and any number of additional computing resources 114 as illustrated by the ellipses. The computing resources 106, 110, and 114 (and any of the other computing resources discussed herein including computing resources 120, 124, 128, 134, 138, and 142) can be any type of computing resource such as, but not limited to, AI resources, processing resources, compute memory resources, and storage resources. Accordingly, the embodiments disclosed herein are not limited by the number or type of computing resources included in a logically composed system or a static system.

The computing resource 106 is assigned a trust score 108, the computing resource 110 is assigned a trust score 112, and although not illustrated, the additional computing resources 114 are also assigned a trust score. The trust scores 108 and 112 (and the trust scores of the additional computing resources 114) are based on underlying security posture of the resources. For example, such security postures can include, but is not limited to, location of the resource (i.e., is it located in a secure location), the accessibility of the resource (i.e., is it generally accessible or does it have controlled access), or the trustworthiness of the owner of the resource. The trust scores can also be based on underlying security policies of a workload that will be executed by the resources, where the underlying security policies specify the security expectations of the workload.

In addition to the trust scores of each of the computing resources, the logically composed system 104 is assigned an overall trust score 116 that is based on the trust scores 108 and 112 (and the trust scores of the additional computing resources 114). For example, in one embodiment the overall trust score 11 can be an average of the trust scores of the computing resources.

The resource pool 102 includes or otherwise has access to the logically composed system 118. The logically composed system 118 includes a computing resource 120, a computing resource 124, and any number of additional computing resources 128 as illustrated by the ellipses. The computing resource 120 is assigned a trust score 122, the computing resource 124 is assigned a trust score 126, and although not illustrated, the additional computing resources 128 are also assigned a trust score. The trust scores 122 and 126 (and the trust scores of the additional computing resources 128) are based on underlying security posture of the resources and on the underlying security policies of a workload that will be executed by the resources in the manner described in relation to logically composed system 104. In addition to the trust scores of each of the computing resources, the logically composed system 118 is assigned an overall trust score 130 that is based on the trust scores 122 and 126 (and the trust scores of the additional computing resources 128) in the manner described in relation to logically composed system 104.

The resource pool 102 includes or otherwise has access to the static system 132. The static system 132 includes a computing resource 134, a computing resource 138, and any number of additional computing resources 142 as illustrated by the ellipses. The computing resource 134 is assigned a trust score 136, the computing resource 138 is assigned a trust score 140, and although not illustrated, the additional computing resources 142 are also assigned a trust score. The trust scores 136 and 140 (and the trust scores of the additional computing resources 142) are based on underlying security posture of the resources and on the underlying security policies of a workload that will be executed by the resources in the manner described in relation to logically composed system 104. In addition to the trust scores of each of the computing resources, the static system 132 is assigned an overall trust score 144 that is based on the trust scores 136 and 140 (and the trust scores of the additional computing resources 142) in the manner described in relation to logically composed system 104. Although not illustrates, the additional systems 146 also include various computing resources that are each assigned a trust score and the additional systems 146 each have an overall trust score based on the trust scores of their various computing resources.

The secure resource management system 100 includes the trust score module 150. The trust score module 150 includes a trust score engine 156. In some embodiments, the trust score engine 156 determines the security posture of logically composed system 104, logically composed system 118, static system 132, and any of the additional systems 146 and also determines the security policies of the workloads that are to be executed. The trust score engine 156 is then able to assign the trust scores to each of the computing resources and the overall trust scores for the systems previously described. In other embodiments, the trust scores to each of the computing resources and the overall trust scores for the systems can be assigned by another entity and accessed by the trust score module 150.

The trust score module 150 includes a computing resource trust score map 158. In operation, computing resource trust score map 158 continually maps the overall trust scores of the each of the systems included in the resource pool 102 and each of their underlying computing resources. Thus, as shown in FIG. 1B, computing resource map 158 maps the overall trust score 116 and the trust scores of the 108 and 112 of the computing resources 106 and 110 (and, although not illustrated, any trust scores of the additional computing resources 114) of logically composed system 104. Computing resource map 158 also maps the overall trust score 130 and the trust scores 122 and 126 of the computing resources 120 and 124 (and, although not illustrated, any trust scores of the additional computing resources 128) of logically composed system 118. Computing resource map 158 further maps the overall trust score 144 and the trust scores 136 and 140 of the computing resources 134 and 138 (and, although not illustrated, any trust scores of the additional computing resources 142) of static system 132. Computing resource map 158 will also map the overall trust score for any of the additional systems 146 and trust scores of their respective computing resources. The trust score module 150 also includes a trust score change detection module 152 that includes a remediation module 154 that will be explained in more detail to follow.

The secure resource management system 100 receives various workflows from users for execution by one or more of the systems of the resource pool 102. For example, the secure resource management system 100 can execute a workflow 160, a workflow 164, a workflow 168, and any number of additional workflows 172 as illustrated by the ellipses.

Each of the received workflows is associated with trust score criteria. The trust score criteria specifies the underlying security policies and security expectations of the user who owns or generates a workflow. In other words, the trust score criteria informs the secure resource management system about the level of trust for the executing system that is expected by the user who owns or generates the workflow. The trust score criteria includes a trust score threshold that specifies an acceptable trust score for the system that will execute the workflow as will be explained in more detail to follow. For example, the workflow 160 includes trust score criteria including a trust score threshold 162, the workflow 164 includes trust score criteria including a trust score threshold 166, the workflow 168 includes trust score criteria including a trust score threshold 170, and, although not illustrated, the additional workflows 172 are associated with trust score criteria having a trust score threshold.

Accordingly, the secure resource management system 100 includes the schedule module 148. In operation, as will be explained in more detail to follow, schedule module 148 enforces the trust score criteria by deploying the received workflows for execution only on one or more of the systems of the resource pool 102 that meet or exceed the trust score threshold. In addition, trust score module 150 includes the trust score change detection module 152 that includes the remediation module 154. In operation, as will also be explained in more detail to follow, the score change detection module 152 monitors the overall trust scores of the systems of the resource pool 102 and the trust scores of their respective computing resources. If any changes in the trust scores are detected, the computing resource trust score map 158 is updated to reflect the changes. In addition, when an overall trust score of a system that is executing a workflow falls below the trust score threshold, the remediation module 154 generates an alert and then either takes or suggests a remediation plan that will help retore the overall trust score to a level that satisfies the trust score threshold.

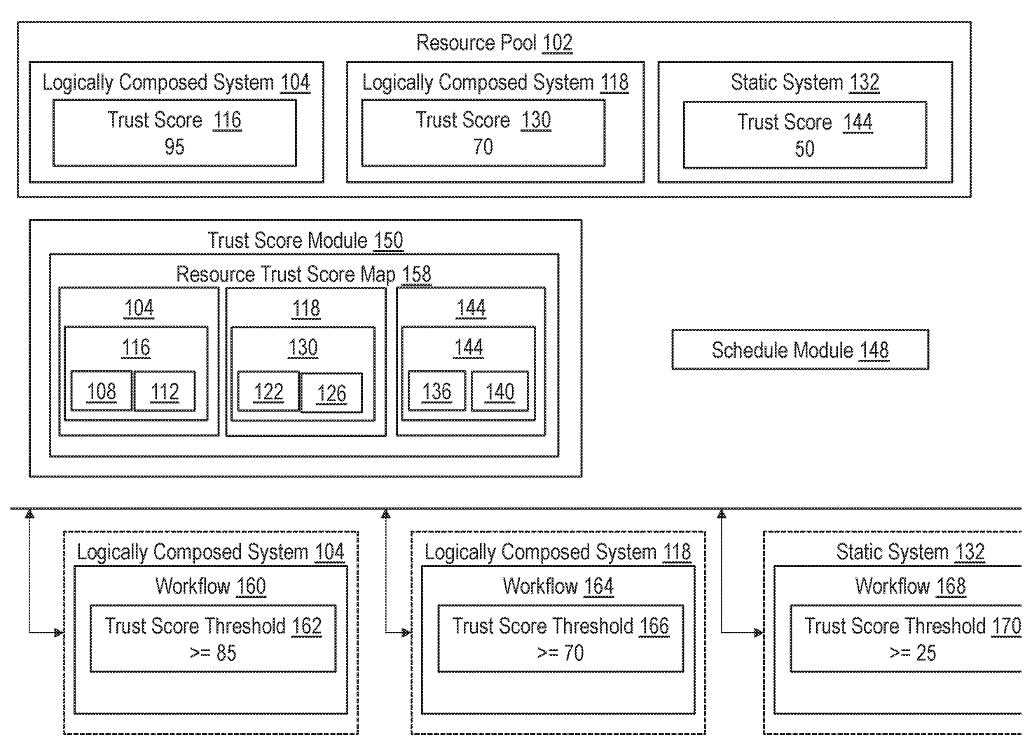

FIG. 2 illustrates an embodiment of the schedule module 148 enforcing the trust score criteria by deploying the received workflows only on one or more of the systems of the resource pool 102 that meet or exceed the trust score threshold. For ease of illustration and explanation, FIG. 2 shows a simplified version of the the secure resource management system 100 of FIGS. 1A and 1B. Thus, it will be appreciated that the simplified version of the secure resource management system 100 includes the elements shown in FIGS. 1A and 1B that are not shown in FIG. 2.

As illustrated in FIG. 2, in the embodiment the trust score threshold 162 of the workflow 160 has a trust score threshold of greater than or equal to 85, which indicates that the workflow 160 includes relatively sensitive data such as human resource data or medical data and thus needs to be executed on a system having computing resources having a relatively high level of trust. The trust score threshold 166 of the workflow 164 has a trust score threshold of greater than or equal to 70, which indicates that the workflow 164 includes data that is not as sensitive as the data of workflow 160, but is still sensitive and thus needs to be executed on a system having computing resources having a relatively high level of trust, but not as high as the workflow 160. The trust score threshold 170 of the workflow 168 has a trust score threshold of greater than or equal to 25, which indicates that the workflow 168 includes non-sensitive data such as data related to the scheduling of a conference room and thus can be executed on a system having computing resources having a relatively low level of trust. As also shown in the figure, the overall trust score 116 of the logically composed system 104 has a value of 95, the overall trust score 130 of the logically composed system 118 has a value of 70, and the overall trust score 144 of the static system 132 has a value of 50.

Accordingly, the schedule module 148 will ensure that the workflows are only executed by a system of the resource pool 102 that has an overall trust score that at least meets the minimum trust score threshold of the workload. For example, since the workflow 160 has a trust score threshold of greater than or equal to 85, only the overall trust score 95 of logically composed system 104 meets the minimum trust score threshold of the workload as the overall trust scores of the other systems in the resource pool 102 are less than 85. Thus, in the illustrated embodiment the schedule module 148 deploys the workflow 160 to be executed by logically composed system 104 as illustrated by the dashed lines around the workflow 160.

Likewise, since the workflow 164 has a trust score threshold of greater than or equal to 70, only the overall trust score 95 of logically composed system 104 and the overall trust score 70 of logically composed system 118 meet the minimum trust score threshold of the workload as the overall trust scores of the static system 132 is less than 70. In the illustrated embodiment, the schedule module 148 deploys the workflow 164 to be executed by logically composed system 118 as illustrated by the dashed lines around the workflow 164. Of course, if logically composed system 104 included sufficient resources to execute both the workflow 160 and the workflow 164, then the workflow 164 could also be deployed for execution on logically composed system 104.

In addition, since the workflow 168 has a trust score threshold of greater than or equal to 25, any of the systems of the resource pool 102 meet the minimum trust score threshold of the workload. In the illustrated embodiment, the schedule module 148 deploys the workflow 168 to be executed by static system 132 as illustrated by the dashed lines around the workflow 168. Of course, if logically composed systems 104 and/or 118 included sufficient resources to execute both their respective workflows 160 and 164 and the workflow 168, then the workflow 168 could also be deployed for execution on logically composed systems 104 and/or 118.

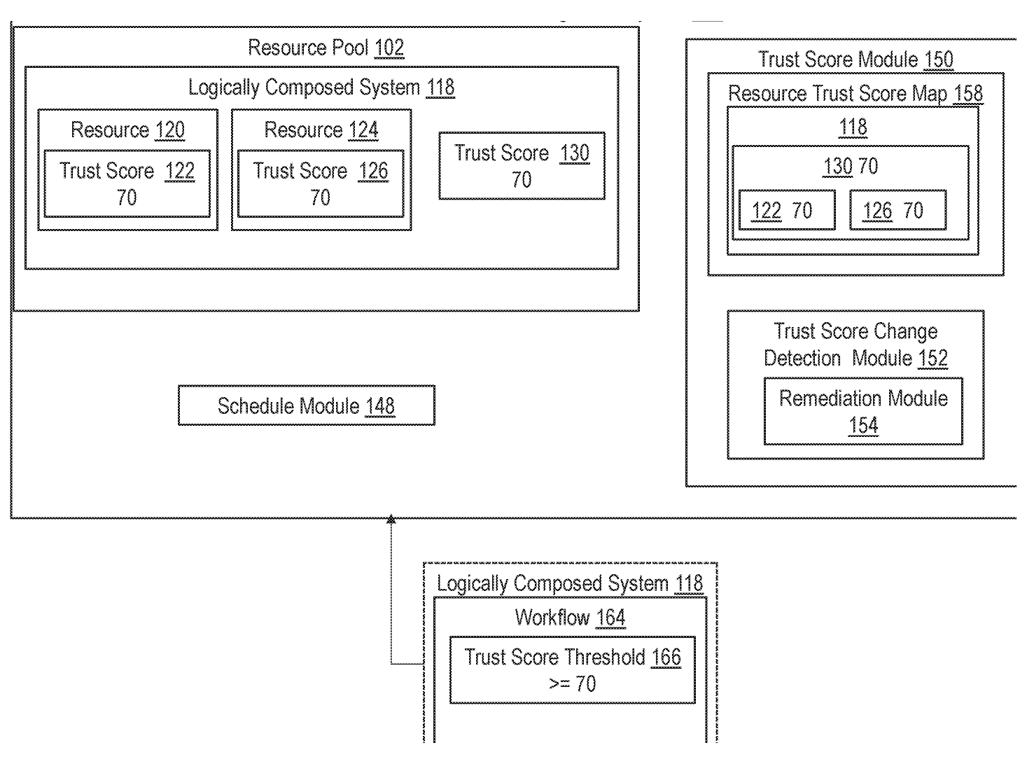

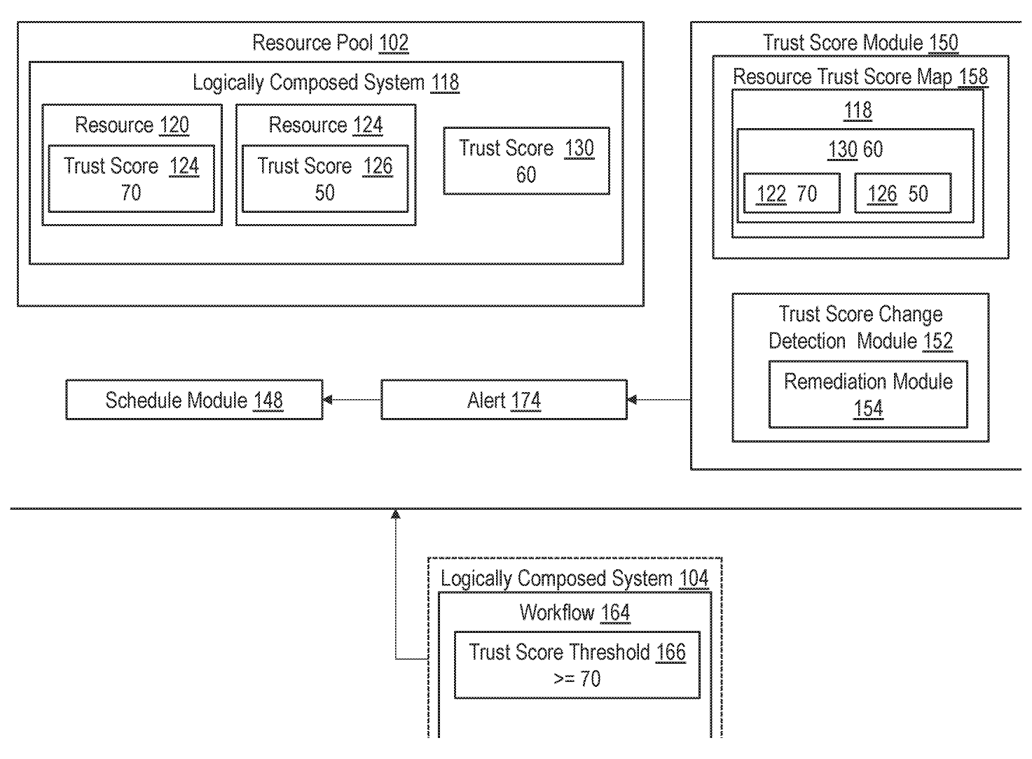

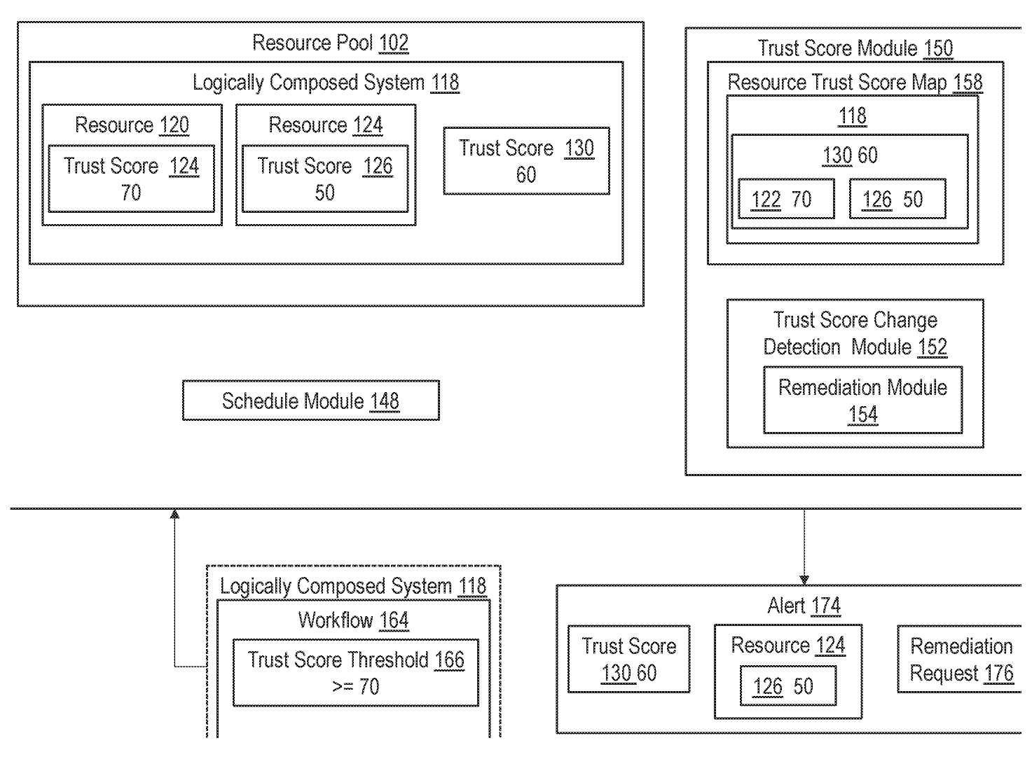

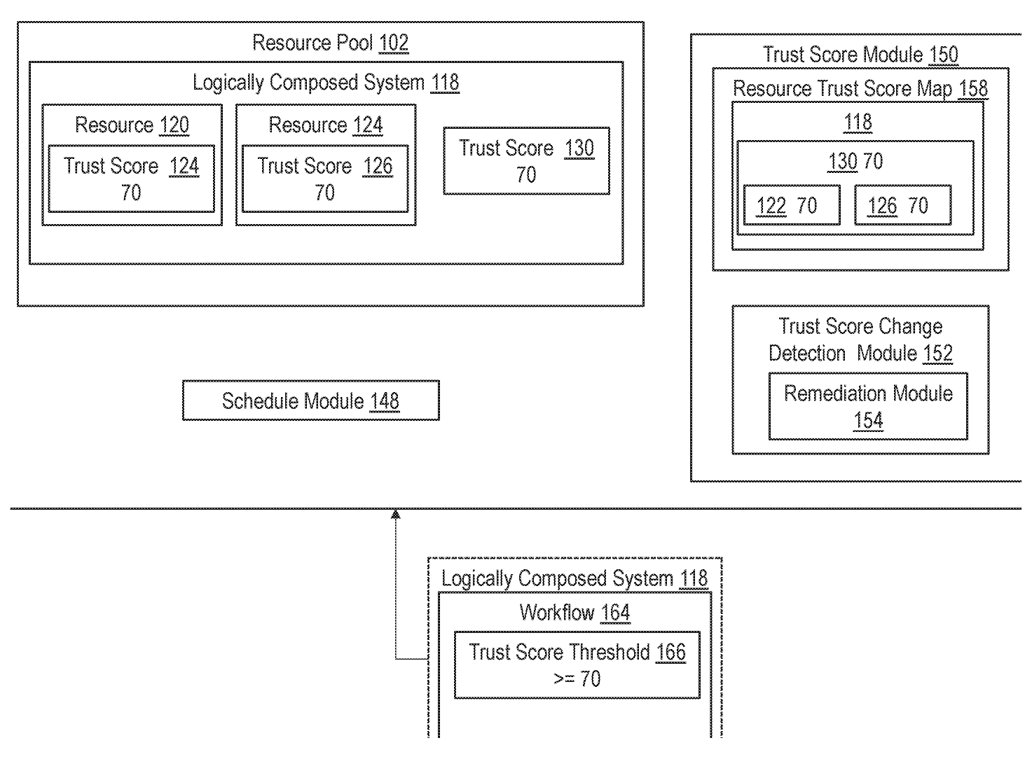

FIGS. 3A-3D illustrate an embodiment of the operation of the trust score change detection module 152 and its remediation module 154. For ease of illustration and explanation, FIGS. 3A-3D show a simplified version of the secure resource management system 100 of FIGS. 1A and 1B. Thus, it will be appreciated that the simplified version of the secure resource management system 100 shown in FIGS. 3A-3D includes the elements shown in FIGS. 1A and 1B that are not shown in FIGS. 3A-3D.

FIG. 3A illustrates that logically composed system 118 includes computing resource 120 that has a trust score 122 of 70 and computing resource 124 that has a trust score of 70. This leads to an overall trust score 130 of 70. As also shown in the figure, the computing resource trust score map 158 maps the trust scores 122 and 126 and the overall trust score 130.

At the time of FIG. 3A, the schedule module 148 has deployed the workflow 164 to be executed by the logically composed system 118 as illustrated by the dashed lines around the workflow 164. This is because the logically composed system 118 has the overall trust score 130 of 70, which meets the trust score threshold of greater than or equal to 70 specified by the trust score threshold 166.

FIG. 3B illustrates a time period after the time period of FIG. 3A. During the time, the trust score 126 of the computing resource 124 has changed from 70 to 50. Thus, the trust score 126 has become lower due to an event at the computing resource 124 that lowers the trust level of the resource. For example, the computing resource 124 may have been taken down for a period of time for maintenance, its location may have changed, it may have suffered an unplanned down time caused by a brief loss of power, it may be suffering from unexpected power cycling, or a new login may have occurred. Of course, other events may have occurred at the computing resource 124 and thus the embodiments disclosed herein are not limited by any particular event that causes the trust score 126 to change. The result of the lowering of the trust score 126 is that overall trust score 130 is lowered to 60. The trust score change detection module 152 detects the change in the trust scores 126 and 130 and updates the computing resource trust score map 158 to reflect the change.

Since the overall trust score 130 has changed to 60, it is now lower than the trust score threshold of greater than or equal to 70 specified by the trust score threshold 166. Accordingly, the remediation module 154 will take remedial action to help ensure that the workflow 164 is executed by a system having the expected trust score threshold. In the embodiment of FIG. 3B, the remediation module 154 generates an alert 174 that specifies that the overall trust score 130 has fallen below the trust score threshold of greater than or equal to 70 specified by the trust score threshold 166. The alert 174 causes the schedule module 148 to redeploy the workflow 164 to be executed by the logically composed system 104 as illustrated by the dashed lines around the workflow 164. As seen in FIG. 2, the logically composed system 104 has the overall trust score 116 of 95, which meets the trust score threshold of greater than or equal to 70 specified by the trust score threshold 166. Thus, the embodiment of FIG. 3B shows that one remedial action the remediation module 154 can take is to cause that a workflow be moved to a system of the resource pool 102 that has an overall trust score that meets the expected trust score threshold of the workflow.

FIG. 3C illustrates the same time period after the time period of FIG. 3B. Thus, FIG. 3C shows that the trust score 126 and the overall trust score 130 have changed as described in FIG. 3B. In the embodiment of FIG. 3C, the remediation module 154 will also take remedial action to help ensure that the workflow 164 is executed by a system having the expected trust score threshold. In the embodiment of FIG. 3C, the remediation module 154 also generates the alert 174 that specifies that the overall trust score 130 has fallen below the trust score threshold of greater than or equal to 70 specified by the trust score threshold 166. In the embodiment of FIG. 3C, the alert 174 specifies that because the trust score 126 of the resource 124 has fallen to 50, the overall trust score 130 has fallen below the expected trust score threshold. In other words, the alert 174 is able to provide specific information about which resource is the cause of the changes to the overall trust score.

In addition, the alert 174 can include a remediation request 176 for an administrator or other user. The remediation requests 176 that action be taken by the administrator or other user to bring the overall trust score 130 back to at least the minimum trust score threshold. Because the remediation module 154 knows the specific computing resource or resources that are causing the overall trust score to be lowered, which in the illustrated embodiment is the computing resource 124, the administrator or other user is able to generate a more specific and targeted remediation plan than if the specific computing resource or resources were unknown. In some embodiments, the remediation request 176 is able to provide suggestions to the administrator or other user that can be included in a remediation plan to bring the overall trust score 130 back to at least the minimum trust score threshold.

FIG. 3D illustrates a time period after the generation of the alert 174. In the embodiment of FIG. 3D, the administrator or other user has followed a remediation plan that has returned the overall trust score 130 back to at least the minimum trust score threshold. Thus, as illustrated, the trust score 126 of the computing resource 124 is again 70, indicating that the issue that caused the event to occur at the computing resource 124 that led to the lowering of the trust score 126 has been corrected. This in turn has resulted in the overall trust score 130 returning to 70. The computing resource trust score map 158 has also been updated.

Because the logically composed system 118 again has the overall trust score 130 of 70, which meets the trust score threshold of greater than or equal to 70 specified by the trust score threshold 166, the logically composed system 118 is able to continue to execute the workflow 164 as illustrated by the dashed lines around the workflow 164. Thus, the embodiment of FIGS. 3C and 3D show that one remedial action the remediation module 154 can take is to generate an alert and remediation request that results in actions being taken to bring the overall trust score back to at least the minimum trust score threshold of the workflow.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

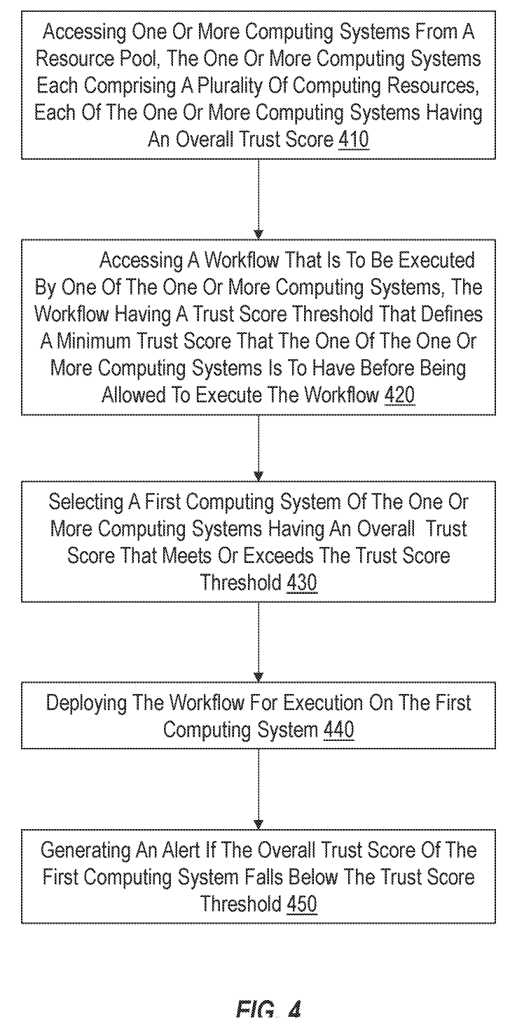

Directing attention now to FIG. 4, an example method 400 is disclosed. The method 400 will be described in relation to one or more of the figures previously described, although the method 400 is not limited to any particular embodiment.

The method 400 includes accessing one or more computing systems from a resource pool, the one or more computing systems each comprising a plurality of computing resources, each of the one or more computing systems having an overall trust score (410). For example, as previously described the secure resource management system 100 accesses logically composed system 104, logically composed system 118, and static system 132 in the resource pool 102. Logically composed system 104 includes computing resources 106, 110, and 114 and has an overall trust score 116, logically composed system 118 includes computing resources 120, 124, and 128 and has an overall trust score 130, and static system 132 includes computing resources 134, 138, and 142 and has an overall trust score 144.

The method 400 includes accessing a workflow that is to be executed by one of the one or more computing systems, the workflow having a trust score threshold that defines a minimum trust score that the one of the one or more computing systems is to have before being allowed to execute the workflow (420). For example, as previously described the secure resource management system 100 accesses one of workflow 160 having trust score threshold 162, workflow 164 having trust score threshold 166, workflow 168 having trust score threshold 170, and the additional workflows 172.

The method 400 includes selecting a first computing system of the one or more computing systems having an overall trust score that meets or exceeds the trust score threshold (430). For example, as previously described the secure resource management system 100 selects one of logically composed system 104, logically composed system 118, and static system 132 from the resource pool that has an overall trust score that meets or exceeds the trust score threshold of the workflow.

The method 400 includes deploying the workflow for execution on the first computing system (440). For example, as previously described the secure resource management system 100 deploys the one of workflow 160, workflow 164, workflow 168, and the additional workflows 172 for execution on the computing system that has an overall trust score that meets or exceeds the trust score threshold of the workflow.

The method 400 includes generating an alert if the overall trust score of the first computing system falls below the trust score threshold (450). For example, as previously described the secure resource management system 100 generates the alert 174.

### Further Example Embodiments

Following are some further example embodiments of the invention. These are presented only by way of example and are not intended to limit the scope of the invention in any way.

Embodiment 1. A method comprising: accessing one or more computing systems from a resource pool, the one or more computing systems each comprising a plurality of computing resources, each of the one or more computing systems having an overall trust score; accessing a workflow that is to be executed by one of the one or more computing systems, the workflow having a trust score threshold that defines a minimum trust score that the one of the one or more computing systems is to have before being allowed to execute the workflow; selecting a first computing system of the one or more computing systems having an overall trust score that meets or exceeds the trust score threshold; deploying the workflow for execution on the first computing system; and generating an alert if the overall trust score of the first computing system falls below the trust score threshold.

Embodiment 2. The method as recited in embodiment 1, wherein the alert specifies a remedial action, the remedial action comprising redeploying the workflow for execution on a second computing system of the one or more computing systems having an overall trust score that meets or exceeds the trust score threshold.

Embodiment 3. The method as recited in any of embodiments 1-2, wherein the alert specifies a remedial action, the remedial action comprising requesting the performance of a remediation plan that causes the overall trust score of the first computing to once again meet or exceed the trust score threshold.

Embodiment 4. The method as recited in any of embodiments 1-3, wherein the alert specifies which of the plurality of computing resources comprising the first computing system has caused the overall trust score of the first computing system to fall below the trust score threshold.

Embodiment 5. The method as recited in embodiment 4, wherein the plurality of computing resources comprising the first computing system each have a trust score and the overall trust score of the first computing system is based on the trust scores of the plurality of computing resources comprising the first computing system.

Embodiment 6. The method as recited in any of embodiments 1-5, further comprising: mapping the overall trust score of the first computing system in a computing resource trust score map.

Embodiment 7. The method as recited in embodiment 6, further comprising: updating the computing resource trust score map when the overall trust score of the first computing system falls below the trust score threshold.

Embodiment 8. The method as recited in embodiment 6, wherein the plurality of computing resources comprising the first computing system each have a trust score, the method further comprising: mapping the trust scores of the plurality of computing resources comprising the first computing system in the computing resource trust score map.

Embodiment 9. The method as recited in any of embodiments 1-8, wherein the first system is a logically composable system where the plurality of computing resources comprising the first computing system are dynamically added to the first computing system.

Embodiment 10. The method as recited in any of embodiments 1-9, wherein the first system is a static system where the plurality of computing resources comprising the first computing system are fixed.

Embodiment 11. A computing system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

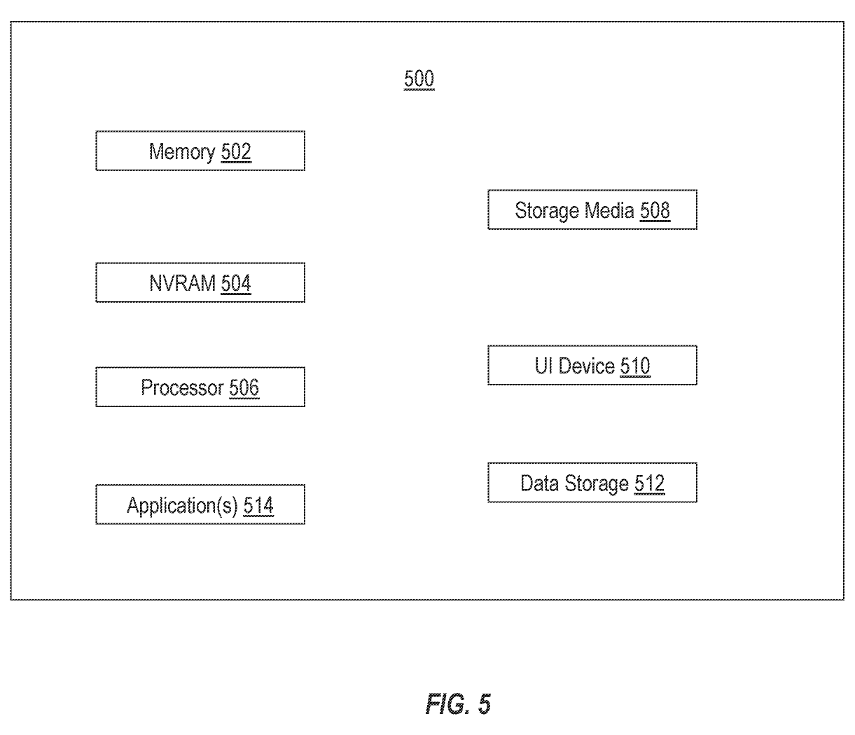

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more components of the memory 502 of the physical computing device 504 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The described embodiments are to be considered in all respects only as illustrative and not restrictive. All changes which come within the meaning and range of equivalency of the claims are to be embraced within their scope.

What is claimed is:

1. A method, comprising:
accessing one or more computing systems from a resource pool, the one or more computing systems each comprising a plurality of computing resources, each of the one or more computing systems having an overall trust score;
accessing a workflow that is to be executed by one of the one or more computing systems, the workflow having a trust score threshold that defines a minimum trust score that the one of the one or more computing systems is to have before being allowed to execute the workflow;
selecting a first computing system of the one or more computing systems having an overall trust score that meets or exceeds the trust score threshold;
deploying the workflow for execution on the first computing system; and
generating an alert if the overall trust score of the first computing system falls below the trust score threshold.

2. The method of claim 1, wherein the alert specifies a remedial action, the remedial action comprising redeploying the workflow for execution on a second computing system of the one or more computing systems having an overall trust score that meets or exceeds the trust score threshold.

3. The method of claim 1, wherein the alert specifies a remedial action, the remedial action comprising requesting performance of a remediation plan that causes the overall trust score of the first computing to once again meet or exceed the trust score threshold.

4. The method of claim 1, wherein the alert specifies which of the plurality of computing resources comprising the first computing system has caused the overall trust score of the first computing system to fall below the trust score threshold.

5. The method of claim 1, wherein the plurality of computing resources comprising the first computing system each have a trust score and the overall trust score of the first computing system is based on the trust scores of the plurality of computing resources comprising the first computing system.

6. The method of claim 1, further comprising:
mapping the overall trust score of the first computing system in a computing resource trust score map.

7. The method of claim 6, further comprising:
updating the computing resource trust score map when the overall trust score of the first computing system falls below the trust score threshold.

8. The method of claim 6, wherein the plurality of computing resources comprising the first computing system each have a trust score, the method further comprising:
mapping the trust scores of the plurality of computing resources comprising the first computing system in the computing resource trust score map.

9. The method of claim 1, wherein the first system is a logically composable system where the plurality of computing resources comprising the first computing system are dynamically added to the first computing system.

10. The method of claim 1, wherein the first system is a static system where the plurality of computing resources comprising the first computing system are fixed.

11. A non-transitory storage medium having stored therein instructions that are executable by one or more hardware processors to perform operations comprising:
accessing one or more computing systems from a resource pool, the one or more computing systems each comprising a plurality of computing resources, each of the one or more computing systems having an overall trust score;
accessing a workflow that is to be executed by one of the one or more computing systems, the workflow having a trust score threshold that defines a minimum trust score that the one of the one or more computing systems is to have before being allowed to execute the workflow;
selecting a first computing system of the one or more computing systems having an overall trust score that meets or exceeds the trust score threshold;
deploying the workflow for execution on the first computing system; and
generating an alert if the overall trust score of the first computing system falls below the trust score threshold.

12. The non-transitory storage medium of claim 11, wherein the alert specifies a remedial action, the remedial action comprising redeploying the workflow for execution on a second computing system of the one or more computing systems having an overall trust score that meets or exceeds the trust score threshold.

13. The non-transitory storage medium of claim 11, wherein the alert specifies a remedial action, the remedial action comprising requesting performance of a remediation plan that causes the overall trust score of the first computing to once again meet or exceed the trust score threshold.

14. The non-transitory storage medium of claim 11, wherein the alert specifies which of the plurality of computing resources comprising the first computing system has caused the overall trust score of the first computing system to fall below the trust score threshold.

15. The non-transitory storage medium of claim 11, wherein the plurality of computing resources comprising the first computing system each have a trust score and the overall trust score of the first computing system is based on the trust scores of the plurality of computing resources comprising the first computing system.

16. The non-transitory storage medium of claim 11, further comprising:
mapping the overall trust score of the first computing system in a computing resource trust score map.

17. The non-transitory storage medium of claim 16, further comprising:
updating the computing resource trust score map when the overall trust score of the first computing system falls below the trust score threshold.

18. The non-transitory storage medium of claim 16, wherein the plurality of computing resources comprising the first computing system each have a trust score, further comprising:
mapping the trust scores of the plurality of computing resources comprising the first computing system in the computing resource trust score map.

19. The non-transitory storage medium of claim 11, wherein the first system is a logically composable system where the plurality of computing resources comprising the first computing system are dynamically added to the first computing system.

20. The non-transitory storage medium of claim 11, wherein the first system is a static system where the plurality of computing resources comprising the first computing system are fixed.
